(19) United States
(12) Patent Application Publication
(10) Pub. No.: US 2015/0039509 A1
(43) Pub. Date: Feb. 5, 2015

(54) PORTABLE DEVICE FOR ELECTRONIC PAYMENTS

(71) Applicant: Orlando Fernandes De Sousa Cruz, Leiria (PT)

(72) Inventor: Orlando Fernandes De Sousa Cruz, Leiria (PT)

(21) Appl. No.: 14/375,592

(22) PCT Filed: Jan. 30, 2013
(86) PCT No.: PCT/PT2013/000005

§ 371 Date: Jul. 30, 2014

(30) Foreign Application Priority Data
Jan. 31, 2012 (PT) 106125

(51) Int. Cl. G06Q 20/32; G06Q 20/40; G06Q 20/36

(52) U.S. Cl. CPC G06Q 20/3224; G06Q 20/3229; G06Q 20/36; G06Q 20/407
USPC 705/44

(57) ABSTRACT

“Portable device for electronic payments” or “Electronic wallet calculator for cashless transactions” refers to a combined system of conversion, calculation and transmission of processed data for immediate and presencial payments and revenues, through portable or fixed devices of close but contactless communication, which, in most models, is similar to a wallet calculator or a mobile phone, in which the basic functions of arithmetic operations designed to be subtraction (debit) or addition (credit) are only performed, whenever two similar or compatible devices establish a link of connectivity and synchronization of the processed, encoded and encrypted data between themselves, in a secure and off-line way, using infrared, radio frequency of short distance, or other forms of “contactless” transmission.

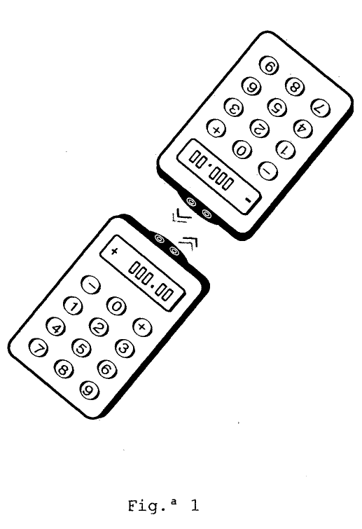

Combined system for synchronization, conversion, calculating and transmitting of processed data to simultaneous transactions from debit and credit values to be employed in portable or fixed devices and mobile phones.

### BACKGROUND

All known systems of direct or remote payment which were developed, patented and implemented according to the current state of the art for electronic cashless transactions and other offline and online systems that represent digital cash are based on issuing systems of payment orders on current, stored, control and loyalty accounts. For this purpose, and through applications on portable or fixed mobile devices, they can transfer data, funds or credits, that were stored in the memory of the respective accounts or platforms to other accounts or systems.

This fact implies inevitable security risks, such as the interception and the use of the transferred data by a third party, the dual use of the electronically presented figures/values (double spending) and the spread of the electronic trail left on all transactions.

To reduce or end the insecurity within electronic transactions and its consequences, there is only a solution that has no correspondence with any method, system or process of transfer of data, funds or stored credits, which will recognize the same advantages of real money, in terms of security, anonymity, autonomy and independence, in the systems of payments and revenues without money “cashless” or offline transactions.

A “cashless” payment system that achieves the transaction of debit and credit values/figures, without implying any transfer of data or funds, that are stored in the memory of the respective accounts, will undoubtedly reduce the whole necessary technical approach, in order to grant an efficient solution to attain safe, reliable payments, in terms of value, integrity, efficiency, economy and acceptance.

There is currently no other process, method or proposal for “cashless” electronic transactions and payments, whose data might be transmissible, but not transferable, and also integrated in an off-line system, that should be:
independent of banks, mobile operators or servers;
autonomous 24 hours a day in real time and anywhere;
100% safe and free of costs, fees or commissions;
anonymous and devoid of personal or confidential information;
accepted and recognized by everyone, including minors and people, who don't use any bank or network;
free and unbound to usage, loyalty or acceptance contracts;
inviolable, unchangeable, not duplicable and immune to all kinds of fraud;
compatible with assisted or unassisted manual or mechanical processing transactions, done in vending and automatic payment machines;
it must allow payments in presence (face to face or person to person) (P2P);
which exempts the dialing of codes and the employment of techniques of authentication, of privacy, authorization and non-rejection;
and which does not require the access to mobile communication networks, terminals or systems of banking processing.

### INTRODUCTION

Assigned to the category of mobile interface systems for processing and conversion of encrypted, tradable and non-transferable data, the new integrated calculator for electronic payments and revenues, proposes a new, innovative, pioneering solution for applications in new processes of dematerialization payments or money transactions that use mobile or fixed devices which work either by remote connection or physical presence, including mobile phones or POS terminals, in order to replace cash (coins and paper money) with electronic or digital money, thus ensuring the same standards of value, safety, integrity, anonymity and convenience as those given by cash payments.

It is about an integrated solution for electronic transmission and connection, which is established between two communication devices, that are near but contactless, synchronized by a system of transmission, conversion, calculation and processing of tradable data, respecting presencial payments and revenues.

It can be also adapted to do transactions of remote, such as those accomplished through SMS or direct ATM, to reload and unload the account balance, by means of the available devices associated to a bank account.

All operations concerning presencial payment and revenue transactions are independent of the regulator's, financial's or mobile operator's examination and authorization, being thus free of cost validation and authentication.

Operating in an autonomous system, in which values or credits can be stored in the memory of that system, you can avoid persistent access connections to mobile communication networks and to bank processing systems. This is the main advantage for transactions of low value or of high frequency, for terminal payments or of automatic charge, for payment of products and professional services, that do not accept any other sort of electronic payment, for transactions between individuals and between people without bank transactions and for confidential or circumstantial transactions, that are assumed in any place, time, situation or action and in locations without access.

All functions associated with the new process of monetary validation intend to replace payments that use coins, paper money, prepaid and debit cards by the new electronic transaction system, from a simple wallet calculator or mobile phone, turned into an e-wallet that pays and receives payments, in a single device that combines connection, synchronization and simultaneous bidirectional transmission of data to be converted into debt and credit values, which are tradable between two connected parties (debtor and creditor). Operating through a system of coded access and protected by encryption, which allows us to recognize the authenticity of the attached devices and the compatibility mode of the encrypted data, you can perform the respective operation of calculation (addition or subtraction), commanded by each one of the two synchronized calculators.

The advantages of the new application for presencial transactions between natural or legal persons, traders, companies or institutions that use the new system of regulation, accreditation, certification and electronic portability for payments and revenues, includes—besides safety, comfort, simplicity, convenience, economy, autonomy and independence—the universal acceptance of a mobile system that manages all transactions around the “digital cash”, which is available in a “cardless”, an anti-coins e-wallet that carries no personal data, thus ensuring absolute security of “cashless” transactions and anonymity, confidentiality and privacy in the performed transactions.

It also has the advantage of being able to control every cent spent and every performed movement, to consult the available or accumulated balance at any time and to make payments through ATM terminals or through vending machines and automatic charge.

Built on the concept of universal electronic money, it is the only free system that fulfils the role of digital cash entirely, as this digital cash is anonymous and autonomous, irreversible and convertible, of stable, unalterable, transmissible, non-transferable, non-duplicable, of unrestricted and not terminable value, ensuring thus all requirements of safety, confidence, integrity, reliability, authenticity and acceptance.

### CONCLUSION

The present invention, called Portable device for electronic payments or “Electronic wallet calculator for cashless transactions”, refers to a combined system of conversion, calculation and transmission of processed data for presencial, cashless, offline and in loco payments and revenues, which is established between two portable or fixed communication devices, which are near but without contact, and through which a connection signal is created, via infrared or radio frequency of short distance, which enables the synchronization of a simultaneous bidirectional transmission of encrypted, non-transferable data from an encrypted matrix that can be only recognized by the encoded device with the same key. In this way, the respective operation of calculation (addition or subtraction) can be done by each one of the two connected calculators, provided that the typed value of the transaction is equal in both and that the signal of the operation is reversed, thus validating any immediate transaction with output/debit values converted to digits on the display of the calculator that subtracts the payable amount in the memory of its balance, simultaneously showing the same credit converted into digits on the display of the other calculator, that sums the amount it receives in the memory of its account's balance.

The operation mode of the present invention refers essentially to the adaptation and integration of the basic functions of an arithmetic calculator into a communication device, which establishes a contactless proximity, so that a connectivity link between two identical or compatible devices may be established. This happens through the synchronization via infrared, radio frequency of short range, which allows you to perform and validate the respective operation of calculation. That operation will be organized and assumed by each one of the two involved parties in the transaction (debtor and creditor), without any interference of a third party (financial agents or network operators) and does not involve any data transfer, funds or credits stored in the memory of the respective calculators.

It follows that the new tool enables you not only to pay but also to receive payments by simply adding or subtracting the value of the transaction in the respective memory of the calculator. This is only possible when two equal or compatible devices respectively assume the condition of one of the parties (debtor or creditor), establishing a contactless connection of proximity between each-other, that can be achieved via infrared or radio frequency of short distance, provided that both type in the same value and that both perform an inverse operation of calculation.

The connection between the (two) devices or systems is protected by a proper encryption, so that only compatible devices may assume the corresponding synchronization, making the arithmetic operation of the two calculators possible, whose count is subtracted or added to the respective memory. Thus, the payment transaction and revenue is established, and accepted by the two parties.

According to the invention, the portable system for cashless transactions comprises an electronic device, which is like a wallet calculator or a mobile phone in most models; it has got a keyboard until 16 keys, an eight-digit numeric display or a numeric display of one or two rows of 16 characters and an integrated system of programming, memory and arithmetic calculation for the operations of addition, subtraction and percentages, a sender and receiver module of infrared or radio frequency of short range, a communication module for “SMS”, a system of encryption and personal authentication linked to a personal card “SIM”, a converter of connectivity and compatibility, the system date/clock, a security module and an appropriate protocol to protect the adopted systems, and a battery power supply.

Besides the functions of simultaneous processing of conversion and calculation, communication and compatibility, the portable device for payments and revenues includes a registration system to consult the transactions performed in two separate memories, a sound signal to confirm each transaction, a personal authentication system connected to a communication module by SMS for transactions linked to a bank account, and an associated warning and lock system in case of error processing, anomaly, intrusion or attempted violation of the system.

According to its claims, the present invention is an alternative solution to the existing payment systems, by combining the functions of payment and revenue from the same device; by being autonomous and independent of mobile operators, regulators and financial institutions or systems; and by allowing the debit and credit transaction without the need of connection to terminals or mobile networks, ensuring presencial transactions without costs, in real time and everywhere; by replacing payments in cash (coins and paper money) of all mechanical or manual processes through its adaptation to automatic charging and vending machines, fixed payment terminals, cash registers and ATMs; by admitting the transaction of debit or credit values, through mobile network SMS or through wireline ATM, to the associated bank account; and by excluding from its system all personal data that require the transfer or transmission of such data, jeopardizing the anonymity, the confidentiality and the privacy of transactions.

The integrated circuit systems, establishing the connection between the components or modules that form the new “cashless” payment device, admit multiple forms and possibilities of implementation and programming, which do not restrict or alter the scope and objective of the present invention, thus eliminating the presentation of any drawings or diagrams, that could be necessary to its understanding.

Merely as an example and without being restrictive, a way of implementing and operating the invention will be described below. To do that the following instructions are going to be employed for a reference model, from now on named calculator:

1—As soon as the value of the transaction is stipulated, each one of the parties (debtor and creditor) connects the calculator on his/her device pressing the signal (0). Then he/she types the value of the operation, so viewing in the display the respective importance.

2—The two devices must come near to each other, a span away from each other, so that the transmission connection is straight, and in that position the debtor presses the signal (−) while the creditor presses the signal (+), until two zeros appear in the respective displays and a beep is heard, confirming at the time of the transaction that the arithmetic operations of each one of the two calculators were held; otherwise they will be locked and the operations won't done, since there was one of the 5 possible errors:

a) The typed values for the transaction in the two calculators are not equal;

b) The typed signals of addition or subtraction in the two calculators are equal;

c) The subtracting value in one of the calculators is higher than the value of the respective memory;

d) A failure or malfunction of the system was detected;

e) One of the calculators is not compatible;

3—To consult the balance of the current account in the memory, you should neatly click on the keys with signal (0) and (+).

To consult the last transaction and all prior transactions click repeatedly on the key signal (−) after clicking on the keys signal (0) and (+) that start the consultation.

4—To clean or bring to zero the indicated value on the display neatly click on the keys signal (+) or (−) and (0).

5—To turn off the calculator and the device, click neatly on the signal keys (0) and (−).

6—To load or unload the calculator with a debit or a credit balance through ATM and from an associated bank account, enter the value and click the signal of the desired operation (+) or (−), and then type up the link key SMS, following the instructions you will receive from the registered mobile phone number, where the operation data and the request of reply to this situation are posted, so that the typed operation in the calculator may be immediately handled.

7—To load or unload the calculator with a debit or a credit balance through ATM and from an associated bank account, you must use the ATM card to access the respective bank account and to access the menu of operations “Rutbanking” so that, when approaching the portable display “Contactless” to the ATM panel, the entered transaction in the calculator may run.

8—To make payments on machines for automatic debits/charges, prepayment machines, vending machines, terminals or payment controllers, follow the instructions, so that, by approaching the portable device of the contactless display of those machines, the entered operation in the calculator may run.

1-9. (canceled)

10. Portable device for electronic payments, comprising:
a pocket calculator, or a mobile phone calculator integrated in a system of proximity communication without contact, and further comprises a hardware component with an infrared transmitter and receiver or radio of short frequency, a microcontroller for conversion and data synchronization, a microprocessor for calculating arithmetic and programming, an additional memory, a screen calculator with control keys for arithmetic functions of addition and subtraction, including the numerals 0-9 and function of activation of memory, a display or screen display, a component firmware, an identification card SIM, a SMS communication module, a system of date/clock, a security module, and a battery or power source,
wherein the fact that the calculator or calculation module, built-in the contactless communication device, establishes a reciprocal link or connection between two equal or compatible devices, which are synchronized via infrared, or radio of short frequency, in order to process the respective operation of calculation, which is ordered and executed by each of the involved par-ties in a transaction between debtor and creditor, without implying any transfer of funds or stored data in the respective memory.

11. Portable device for electronic payments according to claim 10, wherein the means of the interface user, the keyboard and the display panel, establish the simultaneous and synchronous control of the conversion, connection, transmission, calculation and memory functions.

12. Portable device for electronic payments according to claim 10, wherein communication and interoperability between the two devices is only established if the encoded data of hardware authentication are recognized by both.

13. Portable device for electronic payments according to claim 10, wherein the data of arithmetic programming, that entered in both calculators, establish a simultaneous two-way transmission between two connected devices, when the entered values into the calculators are equal, arithmetic operations are reversed, and the subtracted values are equal to or less than the amounts accumulated in the respective memory.

14. Portable device for electronic payments according to claim 10, wherein the arithmetic operations of addition and subtraction are only executed and processed when two compatible devices are connected to each other and the entered data in the two calculators are equally and simultaneously synchronized.

15. Portable device for electronic payments, according to claim 10, wherein the accumulated values in the calculator memory and the last added or subtracted values from this account are recorded in the additional memory, so that they can be displayed in the display or preview pane.

16. Portable device for electronic payments, according to claim 10, wherein the added, subtracted or accumulated values in the memory of a calculator are shown on the display or on the display panel and represent the money, funds or credits that are generated, stored or deleted automatically, when an operation or transaction is performed between debtor and creditor.

17. Portable device for electronic payments according to claim 10, wherein the encoded data of hardware authentication are irreversibly erased automatically, in order to block the functions of the calculator, when the device or system is subjected to an adverse, unauthorized or un-planned action.

18. Portable device for electronic payments, according to claim 10, wherein the devices comprise an expiration date, which is certified by an authority that is a financial entity and an issuer of electronic money, to convert in money all the values, which are stored in the memory of the calculators.
